(19) United States
(12) Patent Application Publication
(10) Pub. No.: US 2012/0261144 A1
(43) Pub. Date: Oct. 18, 2012

(54) Fire Management System

(75) Inventors: John Lyle Vian, Renton, WA (US); Emad William Saad, Renton, WA (US)

(73) Assignee: THE BOEING COMPANY, Chicago, IL (US)

(21) Appl. No.: 13/086,521

(22) Filed: Apr. 14, 2011

(51) Int. Cl. A62C 3/00; A62C 27/00

(52) U.S. Cl. 169/43; 169/52

(57) ABSTRACT

A method and apparatus for managing fires. A computer system is configured to receive fire related information from at least a first portion of a plurality of assets and analyze the fire-related information to generate a result. The computer system is configured to coordinate an operation of a second portion of the plurality of assets using the result.

### BACKGROUND INFORMATION

1. Field

The present disclosure relates generally to fires, and in particular, to fire management systems for detecting and managing fires.

2. Background

Fires may occur in various geographic areas. For example, fires may occur in both urban areas and in rural areas. Fires that occur in the countryside or in wilderness areas can be problematic. This type of fire also may be referred to as a wildfire, a brush fire, a bush fire, a forest fire, a grass fire, or some other type of fire. A wildfire may be extensive in size and may spread quickly, depending on wind and moisture conditions at the time of the fire. Further, this type of fire also may change direction unexpectedly and/or jump across gaps, such as roads, rivers, and/or fire breaks.

Wildfires may be started in response to natural causes, such as, for example, without limitation, lightning, volcanic eruption, sparks from rock falls, spontaneous combustion, and/or other various sources. Fires also may have human and manmade causes, such as, for example, without limitation, arson, discarded cigarettes, sparks from equipment, power line arcs, and/or other types of manmade and human sources.

With respect to these and other types of fires, fighting or containing these and other types of fires often relies on early detection of the fires. Currently, fires may be identified using public hotlines, fire lookouts and towers, ground and aerial patrols, and/or other types of detection. Identifying fires through human observation may be limited by operator fatigue, time of day, time of year, and/or geographic location.

The use of satellites and sensors has increased in identifying fires in forests and other wilderness areas. Using satellites and sensors may involve using satellite data, aerial imagery, sensor data, and/or information collected by human personnel to identify fires.

For example, wireless sensors may be placed in different locations in a forest and/or in other areas of interest. The sensors may be placed on the ground, in trees, on towers, and/or in other suitable locations. These sensors may detect parameters, such as, for example, without limitation, temperature, carbon dioxide, humidity, and smoke. These types of sensors may be battery powered, solar powered, or rechargeable using currents running through trees or other plant matter.

Although these sensors are useful in detecting fires, placing a sufficient amount of sensors in an area may be time consuming and expensive with large areas to be monitored. Further, the sensors may require maintenance. As a result, the use of sensors may be more expensive and more difficult to maintain than desired.

Satellites may be used to provide information about infrared radiation that may be emitted by fires. Although satellites are useful, these types of satellites may have a short window of observation. Additionally, cloud cover and image resolution also may limit the effectiveness of these types of systems. Use of aircraft with sensors configured to detect fires also provides an additional method for detecting fires. Aircraft, however, may be limited in range and/or conditions in which they are capable of detecting fires.

Therefore, it would be advantageous to have a method and apparatus that takes into account at least some of the issues discussed above, as well as possibly other issues.

### SUMMARY

In one advantageous embodiment, a fire management system comprises a computer system. The computer system is configured to receive fire-related information from a heterogeneous group of vehicles. The computer system is further configured to analyze the fire-related information to generate a result. The computer system is further configured to coordinate an operation of the heterogeneous group of vehicles using the result.

In another advantageous embodiment, a method for managing fires is provided. Fire-related information is received from a heterogeneous group of vehicles. The fire-related information is analyzed to generate a result. An operation of the heterogeneous group of vehicles is coordinated using the result.

In yet another advantageous embodiment, a fire management system comprises a computer system. The computer system is configured to receive fire-related information from at least a first portion of a plurality of assets and analyze the fire-related information to generate a result. The computer system is configured to coordinate an operation of a second portion of the plurality of assets using the result.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives, and advantages thereof, will best be understood by reference to the following detailed description of an advantageous embodiment of the present disclosure when read in conjunction with the accompanying drawings, wherein:

FIG. 1 is an illustration of a fire management environment in accordance with an advantageous embodiment;

FIG. 2 is an illustration of a block diagram for a fire management system in accordance with an advantageous embodiment;

FIG. 3 is an illustration of different types of assets in accordance with an advantageous embodiment;

FIG. 4 is an illustration of different types of fire-related information in accordance with an advantageous embodiment;

FIG. 5 is an illustration of an unmanned aerial vehicle flying towards a fire in accordance with an advantageous embodiment;

FIG. 6 is an illustration of unmanned aerial vehicles monitoring a fire in a forest in accordance with an advantageous embodiment;

FIG. 7 is an illustration of a vehicle performing containment operations for a fire in accordance with an advantageous embodiment;

FIG. 8 is an illustration of an aerial vehicle monitoring unit monitoring a location at which a fire has been contained in accordance with an advantageous embodiment;

FIG. 9 is an illustration of a flowchart of a process for managing fires in accordance with an advantageous embodiment; and

FIG. 10 is an illustration of a data processing system in accordance with an advantageous embodiment.

### DETAILED DESCRIPTION

In these illustrative examples, the different advantageous embodiments recognize and take into account that currently, the detection of fires are not planned in a manner that may be as efficient as desired. For example, the different advantageous embodiments recognize and take into account that current detection methods rely on sensors in towers or fire towers and/or human personnel spotting the presence of fires and other sources.

The different advantageous embodiments also recognize and take into account that currently, human operators receive this information and use it to determine whether fires are present and whether to request that different fire containment assets perform operations to contain the fires. The containment of fires includes preventing the fires from spreading and/or putting out the fires in these illustrative examples.

Further, the different advantageous embodiments recognize and take into account that the coordination of assets in containing fires may not be as organized as desired. For example, the different advantageous embodiments recognize and take into account that oftentimes, personnel in units on the ground perform operations to contain a fire independently of each other or independently of aerial units that may be present.

The different advantageous embodiments recognize and take into account that the use of a human operator to coordinate these operations may be difficult given the unpredictability that may occur with the progress of a fire. For example, currently, a human operator may be unable to obtain information related to a fire as quickly as desired during the fire. Currently-available systems for obtaining fire-related information may have limitations in certain situations, such as, for example, in darkness, in smoke, near mountainous terrain, in wind turbulence, and/or other types of situations. Further, using these types of systems near locations in which a fire is occurring may increase the risk to the human operators using these systems.

Thus, the different advantageous embodiments provide a fire management system that may be used to detect fires, contain fires, or perform a combination of the two. In an advantageous embodiment, a fire management system comprises a computer system. The computer system is configured to receive fire-related information from at least a first portion of a plurality of assets and analyze the fire-related information to generate a result. The computer system is configured to coordinate an operation of a second portion of the plurality of assets using the result.

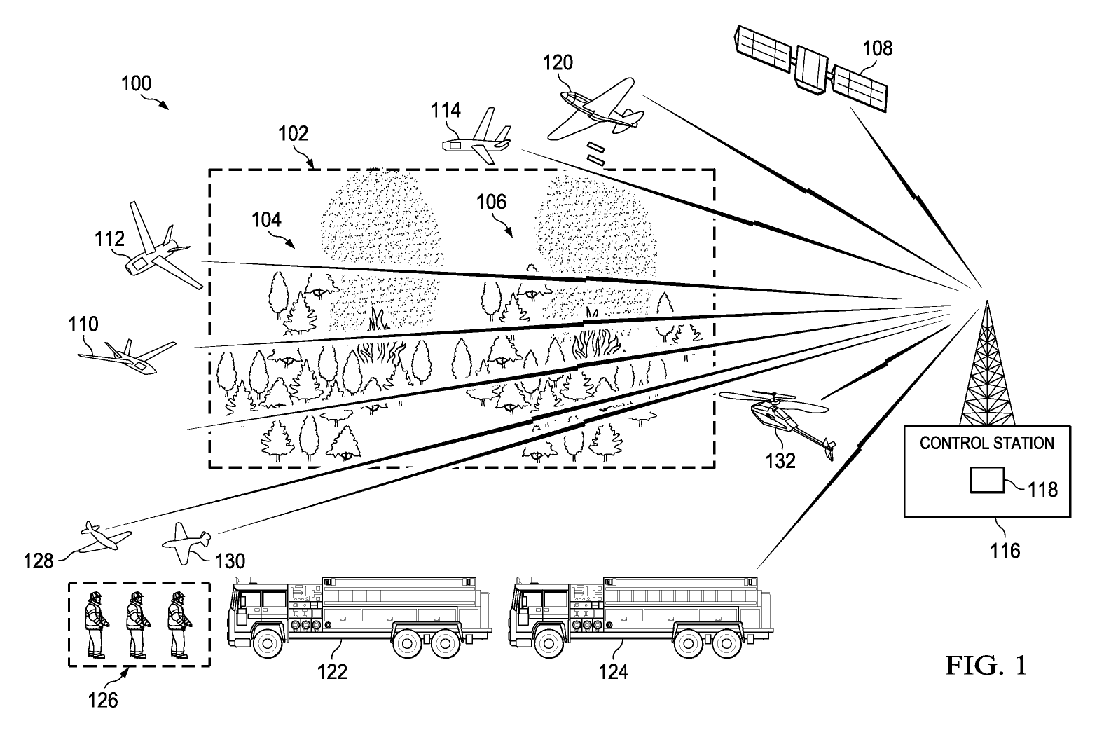

With reference now to FIG. 1, an illustration of a fire management environment is depicted in accordance with an advantageous embodiment. Fire management environment 100 includes various assets that monitor locations, such as location 102, for fires, such as fire 104 and fire 106.

In these illustrative examples, satellite 108, unmanned aerial vehicle 110, unmanned aerial vehicle 112, and unmanned aerial vehicle 114 perform surveillance on location 102, as well as other locations. The surveillance may detect the presence of a fire. For example, when the presence of fire 104 and fire 106 is detected, satellite 108, unmanned aerial vehicle 110, unmanned aerial vehicle 112, and unmanned aerial vehicle 114 use onboard sensors to generate information about fire 104 and fire 106, as well as about location 102.

This information is sent to control station 116. This information may be sent over wireless communications links as fast as can be sent by satellite 108, unmanned aerial vehicle 110, and unmanned aerial vehicle 112. When the information is sent as fast as possible without any intentional delays, this information is considered to be sent in real time and is referred to as real time information.

In these illustrative examples, fire management system 118 is located at control station 116. Fire management system 118 collects the information sent by satellite 108, unmanned aerial vehicle 110, unmanned aerial vehicle 112, and unmanned aerial vehicle 114. Fire management system 118 uses this information to predict the progress of fire 104 and fire 106.

In these illustrative examples, fire 104 and fire 106 may spread in different directions and at different rates, depending on environmental conditions. For example, moisture, vegetation, temperature, wind speed, wind direction, and/or other factors may affect the rate and/or extent to which fire 104 and fire 106 spread.

Fire management system 118 also may direct unmanned aerial vehicle 110, unmanned aerial vehicle 112, and unmanned aerial vehicle 114 in a coordinated fashion to obtain additional information about fire 104 and fire 106.

Additionally, fire management system 118 may direct assets, such as aerial fire containment unit 120 to location 102 to perform containment operations for fire 104 and fire 106. Fire management system 118 also may direct assets, such as ground unit 122, ground unit 124, personnel 126, aerial support unit 128, and aerial support unit 130 to location 102 to perform containment operations for fire 104 and fire 106.

In these illustrative examples, personnel 126 operate ground unit 122 and ground unit 124. As depicted, fire management system 118 may coordinate the operation of aerial support unit 128 and aerial support unit 130 in a manner that provides information to personnel 126 regarding the current conditions of fire 104 and fire 106.

For example, aerial support unit 128 and aerial support unit 130 fly at lower altitudes as compared to satellite 108, unmanned aerial vehicle 110, unmanned aerial vehicle 112, and unmanned aerial vehicle 114. Information about fire 104 and fire 106 may be obtained at these lower altitudes and may not be obtained at the higher altitudes at which satellite 108 orbits and unmanned aerial vehicle 110, unmanned aerial vehicle 112, and unmanned aerial vehicle 114 operate.

Aerial support unit 128 and aerial support unit 130 may be directly and manually controlled by personnel 126. Video feed from aerial support unit 128 and aerial support unit 130 may help the human operators control these vehicles. These different assets, operating in a support role, may provide video and/or other information used to identify the size and direction of fire 104 and fire 106. Additionally, fire monitoring unit 132 may provide information to fire management system 118 about the status of fire 104 and fire 106 during the containment operations performed by the different assets and/or after containment of fire 104 and fire 106.

In this illustrative example, the operation of the different assets, both manned and unmanned, are coordinated by fire management system 118. When these assets are coordinated in this fashion, the assets may be referred to as a swarm.

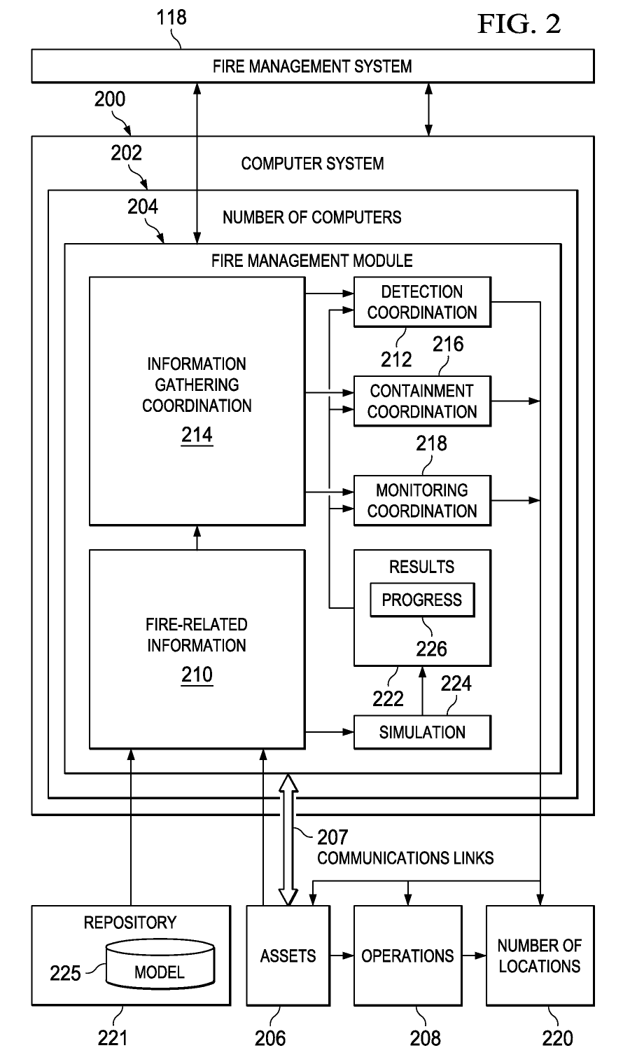

With reference now to FIG. 2, an illustration of a block diagram for a fire management system is depicted in accordance with an advantageous embodiment. In this illustrative example, fire management system 118 from FIG. 1 is illustrated in a block diagram to depict and describe different features that may be present in fire management system 118.

Fire management system 118 may be implemented in part or all of computer system 200 in FIG. 2. Computer system 200 comprises number of computers 202 that may be in communication with each other. A number, as used herein with reference to items, means one or more items. For example, “number of computers 202” means one or more computers.

As depicted, fire management module 204 runs on computer system 200 as part of fire management system 118. Fire management module 204 is software in these illustrative examples. Fire management module 204 is in communication with assets 206 in these illustrative examples. Assets 206 may include, for example, without limitation, a person, a vehicle, a machine, a sensor system, a computer, a satellite system, a ground station, a control tower, and/or other suitable types of objects.

As one illustrative example, assets 206 may include, for example, satellite 108, unmanned aerial vehicle 110, unmanned aerial vehicle 112, unmanned aerial vehicle 114, aerial fire containment unit 120, ground unit 122, ground unit 124, personnel 126, aerial support unit 128, and/or aerial support unit 130 in FIG. 1. Of course, depending on the implementation, assets 206 may include other types of assets.

In these illustrative examples, number of computers 202 for computer system 200 may be located in one or more of assets 206, at a number of control stations, and/or in other suitable locations.

As depicted in these examples, fire management module 204 runs in computer system 200 and communicates with assets 206 using communications links 207. Communications links 207 may include one or more wireless communications links, wired communications links, and/or other suitable types of communications links.

Fire management module 204 is configured to coordinate operations 208 performed by assets 206. Coordinating involves directing assets 206 in a manner that allows for a more-efficient use of assets 206 to perform a mission, task, process, and/or other operation. Coordinating assets 206 may reduce redundancy or overlap in the operation of assets 206 when redundancy or overlap is not desired. Coordinating may include directing assets 206 by, for example, without limitation, sending at least one of a command, a message, a goal, a mission, a task, data, and other information that directs and/or gives guidance in performing operations 208. The coordination may occur in a manner that operations 208 are performed such that some or all of assets 206 may work together as a single group or in multiple groups.

As used herein, the phrase “at least one of”, when used with a list of items, means that different combinations of one or more of the listed items may be used and only one of each item in the list may be needed. For example, “at least one of item A, item B, and item C” may include, for example, without limitation, item A or item A and item B. This example also may include item A, item B, and item C, or item B and item C. In other examples, “at least one of” may be, for example, without limitation, two of item A, one of item B, and 10 of item C; four of item B and seven of item C; and other suitable combinations.

For example, fire management module 204 may coordinate assets 206. Operations 208 may detect presence of a fire, gather fire-related information 210 about any fire detected, contain any fire detected, and/or monitor the status of any fire detected during and/or after containment of the fire. In these illustrative examples, fire management module 204 uses fire-related information 210 to coordinate operations 208 performed by assets 206.

For example, in these illustrative examples, fire management module 204 may receive fire-related information 210 from at least a first portion of assets 206. Fire management module 204 may use this information to coordinate operations 208 performed by a second portion of assets 206. This second portion of assets 206 may include one or more of the first portion of assets 206 and/or one or more different assets within assets 206.

In these illustrative examples, fire-related information 210 may include any information about a fire, conditions that may have a potential to allow a fire to start and/or spread, a location at which the fire is present, a location surrounding a fire, and/or other suitable information that may be used to identify a potential fire condition, detect a fire, contain a fire, and/or monitor the status of a fire. In some cases, fire-related information 210 may include information that may be used to detect the presence of one or more fires.

Fire management module 204 may integrate fire-related information 210 gathered from the different assets in assets 206 to identify operations 208 that coordinate assets 206. Coordination of assets 206 includes detection coordination 212, information gathering coordination 214, containment coordination 216, and/or monitoring coordination 218 of assets 206, in these illustrative examples.

Detection coordination 212 of assets 206 includes coordinating one or more of assets 206 such that any presence of a fire may be detected. For example, one or more of assets 206 may operate in a manner that provides better coverage, more coverage, and/or longer periods of coverage to detect a presence of a fire, as opposed to one or more of assets 206 working independently of each other.

In particular, detection coordination 212 of assets 206 includes coordinating any number of assets 206 that may have the capability to detect the presence of a fire or generate information that may be used to identify the presence of a fire to perform operations such that any fire in number of locations 220 may be detected. As an example, each of assets 206 used to detect a presence of a fire may have different routes such that an area of interest is covered in a manner desired to detect the presence of a fire.

In these illustrative examples, number of locations 220 may include any location that has been selected as an area in which a fire has a potential to occur, currently occurring, has previously occurred, and/or any other suitable location of interest with respect to fires.

In one advantageous embodiment, detection coordination 212 of assets 206 may include coordinating a group of unmanned aerial vehicles to fly over number of locations 220 in which the potential for a fire to occur has been identified. A group of objects, as used herein, means two or more objects. “A group of unmanned aerial vehicles” is two or more of unmanned aerial vehicles. The group of unmanned aerial vehicles may include, for example, unmanned aerial vehicle 110, unmanned aerial vehicle 112, and/or unmanned aerial vehicle 114 in FIG. 1. This coordination of the group of unmanned aerial vehicles may include selecting routes and times for the group of unmanned aerial vehicles that avoid overlapping between the routes and times in a manner that provides a desired level of coverage for number of locations 220.

In another advantageous embodiment, detection coordination 212 of assets 206 may include controlling a plurality of sensor units placed in number of locations 220 to monitor for a presence of smoke levels that indicate the presence of a fire. Of course, in other illustrative examples, detection coordination 212 may include coordinating other types of assets 206 to detect the presence of a fire in number of locations 220.

In these illustrative examples, information gathering coordination 214 of assets 206 may include coordinating any number of assets 206 to gather fire-related information 210. For example, information gathering coordination 214 may include coordinating assets 206 to gather fire-related information 210 for one or more fires that have been detected in number of locations 220.

Further, in some cases, fire-related information 210 may be used by fire management module 204 to detect the presence of a fire prior to the fire being identified. When fire management module 204 uses information gathering coordination 214 of assets 206 to detect a fire, information gathering coordination 214 may be considered a part of detection coordination 212. In other words, detection coordination 212 of assets 206 may include information gathering coordination 214 of assets 206 such that fire management module 204 may detect the presence of a fire.

In these illustrative examples, containment coordination 216 of assets 206 includes coordinating operations 208 performed by any number of assets 206 to contain any fire that may be detected. For example, in response to the detection of a fire, fire management module 204 performs containment coordination 216 of assets 206 to contain the fire.

In one advantageous embodiment, containment coordination 216 includes coordinating an aerial fire containment unit, such as aerial fire containment unit 120 in FIG. 1, to perform containment operations for a fire that has been detected. These containment operations may include, for example, releasing chemicals at the location of the fire to put the fire out and/or stop the fire from spreading.

In these illustrative examples, containment coordination 216 of assets 206 may also include information gathering coordination 214 of assets 206. For example, containment coordination 216 may include coordinating assets 206 to contain a fire using fire-related information 210 gathered by performing information gathering coordination 214 of assets 206.

As one specific example, containment coordination 216 of assets 206 may include directing a number of unmanned ground vehicles and/or manned ground units to move in a direction in which a fire has been predicted to spread using fire-related information 210. For example, fire management module 204 may identify a predicted path for a fire based on fire-related information 210. Fire management module 204 performs containment coordination 216 of the unmanned ground vehicles and/or manned ground units to move in or change directions to move in a direction along the path predicted for the fire.

As another illustrative example, assets 206 may be coordinated to change coverage or a range of coverage of a fire based on a predicted expansion of a fire.

Monitoring coordination 218 of assets 206 includes coordinating any number of assets 206 to monitor the status of a fire that has been detected prior to, during, and/or after containment operations have been performed for the fire. For example, monitoring coordination 218 may include coordinating personnel on the ground, such as personnel 126 in FIG. 1, and a group of ground units to monitor the status of the fire.

Of course, in these illustrative examples, monitoring coordination 218 of assets 206 may also include information gathering coordination 214 of assets 206. In other words, fire management module 204 may perform monitoring coordination 218 of assets 206 using fire-related information 210 gathered from information gathering coordination 214 of assets 206.

In these advantageous embodiments, one or more of the different types of coordination of assets 206 may be performed using different groups of assets 206 and/or a same group of assets 206.

In the processes of detection coordination 212, containment coordination 216, and monitoring coordination 218, fire management module 204 assigns assets 206 to perform tasks based on the capabilities of assets 206. For example, an unmanned aerial vehicle carrying an infrared sensor can be sent for fire monitoring, while a manned helicopter can be sent for fire containment. These vehicles communicate their current capabilities to fire management module 204, which in turn may use this information in coordinating these vehicles and assigning tasks to be performed by these vehicles.

In these illustrative examples, fire management module 204 may use fire-related information 210 to coordinate assets 206 by analyzing fire-related information 210. In particular, fire management module 204 may analyze fire-related information 210 and generate results 222. Results 222 may then be used in coordinating assets 206.

Results 222 may take various forms. For example, results 222 may include at least one of a map identifying a current location of a fire, a prediction of the progress of a fire, a plan for containing the fire, an identification of areas that need a warning about the fire, an identification of an area for evacuation, statistics about the fire, and/or other suitable types of results.

In these illustrative examples, fire management module 204 in computer system 200 may run simulation 224 to generate results 222. Simulation 224 may be, for example, a simulation of a fire that has been detected. In these illustrative examples, running simulation 224 may generate results 222 in the form of progress 226 predicted for a fire. Progress 226 may include a predicted path for the fire, a predicted expansion or spread of the fire, a predicted amount of smoke generated by the fire, a predicted level of toxic fumes generated by the fire, and/or other predicted information relating to the fire.

Simulation 224 is run based on fire-related information 210 obtained from assets 206 in the illustrative examples. Further, in some illustrative examples, simulation 224 may also be run based on fire-related information 210 obtained from repository 221.

Repository 221 may be located in a number of storage devices external to computer system 200 and/or in computer system 200. In some illustrative examples, repository 221 may be considered one of assets 206.

Repository 221 comprises at least one of, for example, without limitation, a number of databases, data structures, files, spreadsheets, logs, charts, maps, images, video streams, airport and landing area data, information about fire suppressant stockpiles, information about lakes, rivers, and other water source locations, and/or other sources of data. In these illustrative examples, repository 221 may include model 225. Model 225 may include, for example, data about fires that have previously occurred and been contained, predicted behaviors for fires, historical data about fires, geographic data related to prior fires, and/or other suitable information that may be useful in running simulation 224 to predict progress 226 of a fire.

In these illustrative examples, fire management module 204 may use results 222 to perform containment coordination 216 and/or monitoring coordination 218 of a fire. Further, while performing containment coordination 216 and monitoring coordination 218 of a fire, fire management module 204 may continue to coordinate assets 206 to gather fire-related information 210.

The different advantageous embodiments provide a system for managing fires using fire-related information 210 gathered from different types of assets 206 and integrated to form results 222 that may be used in managing the fires. The coordination of assets 206 may be performed by fire management module 204 more efficiently as compared to each one of assets 206 being coordinated without the combined fire-related information 210 obtained from all of assets 206.

The illustration of fire management module 204 in computer system 200 in FIG. 2 is not meant to imply physical or architectural limitations to the manner in which an advantageous embodiment may be implemented. Other components in addition to and/or in place of the ones illustrated may be used. Some components may be unnecessary. Also, the blocks are presented to illustrate some functional components. One or more of these blocks may be combined and/or divided into different blocks when implemented in an advantageous embodiment.

For example, in some illustrative examples, fire management system 118 may be located in computer system 200. In other illustrative examples, fire management module 204 may be configured to coordinate assets 206 using other types of coordination other than the ones described above.

Further, in some illustrative examples, fire-related information 210 may be sent to a human operator at computer system 200 for decision-making support to fire management module 204. In other words, the human operator may make decisions about coordinating assets 206 for managing a fire based on fire-related information 210.

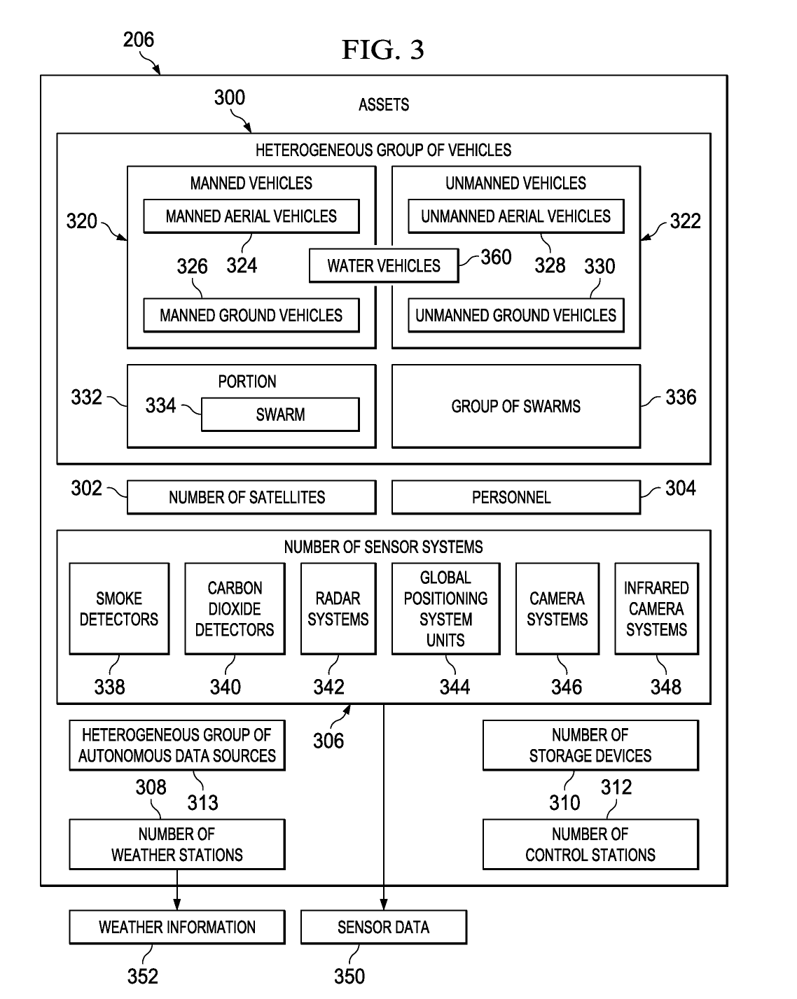

With reference now to FIG. 3, an illustration of different types of assets is depicted in accordance with an advantageous embodiment. In this illustrative example, different types of assets that may be included in assets 206 from FIG. 2 are shown.

As depicted, assets 206 include at least one of heterogeneous group of vehicles 300, number of satellites 302, personnel 304, number of sensor systems 306, number of weather stations 308, number of storage devices 310, number of control stations 312, heterogeneous group of autonomous data sources 313, and other suitable types of assets.

In these illustrative examples, heterogeneous group of vehicles 300 is a group of vehicles in which at least two of the vehicles have a different configuration, different capabilities, are of a different type, and/or are different in some other manner. Heterogeneous group of vehicles 300 includes at least two vehicles selected from at least one of manned vehicles 320 and unmanned vehicles 322. Manned vehicles 320 may include manned aerial vehicles 324 and/or manned ground vehicles 326. Unmanned vehicles 322 may include unmanned aerial vehicles 328 and/or unmanned ground vehicles 330.

Unmanned aerial vehicles 328 may be partially and/or fully autonomous in these examples. Some examples of types of unmanned aerial vehicles 328 include, for example, the Scaneagle, developed by Insitu of the Boeing Company; the Wasp™, manufactured by Aeroenvironment, Incorporated; the Camcopter® S-100, developed by the Sheibel Corporation; and/or other suitable types of unmanned aerial vehicles.

Further, heterogeneous group of vehicles 300 may include other types of vehicles, such as, for example, without limitation, jet airplanes, helicopters, ground units, fire engines, space vehicles, aerial support units, aerial monitoring units, and/or other suitable types of vehicles.

When portion 332 of heterogeneous group of vehicles 300 are coordinated by fire management module 204 in FIG. 2 to perform a number of common tasks or operations and/or achieve a common goal, portion 332 of heterogeneous group of vehicles 300 may form swarm 334. Portion 332 may be some or all of heterogeneous group of vehicles 300. In these different illustrative examples, a swarm of vehicles may operate collectively. In other words, a swarm may have a collective behavior with respect to each other and the environment around the swarm of vehicles.

In some illustrative examples, fire management module 204 may coordinate swarm 334 by sending commands to each of the vehicles within swarm 334. When swarm 334 includes portion 332 of manned vehicles 320, these commands, and/or other suitable information, may be displayed to operators of portion 332 of manned vehicles 320. When swarm 334 includes portion 332 of unmanned vehicles 322, the commands may be displayed to the operators controlling portion 332 of unmanned vehicles 322 remotely and/or sent to computer systems on board portion 332 of unmanned aerial vehicles 328.

In one advantageous embodiment, swarm 334 comprises unmanned aerial vehicles 328 and unmanned ground vehicles 330. With this implementation, fire management module 204 can coordinate operations performed by swarm 334 such that all of the vehicles in swarm 334 move collectively in a direction along a path selected by fire management module 204.

For example, if a path of expansion for a fire is predicted to change based on changing wind speed and/or direction provided in fire-related information 210 in FIG. 2, fire management module 204 may direct swarm 334 to change a current direction of travel for swarm 334 to a new direction along the new path predicted for the fire.

In other illustrative examples, vehicles in swarm 334 may be coordinated to move in different directions around a location of a fire to perform a common goal or task. For example, in some cases, different vehicles in swarm 334 may be coordinated to monitor different areas near the location of a fire to monitor for air quality and/or provide support to other vehicles performing containment operations.

In some illustrative examples, heterogeneous group of vehicles 300 may be coordinated such that heterogeneous group of vehicles 300 form group of swarms 336. In other words, fire management module 204 may coordinate more than one swarm to perform various operations to manage a fire.

Additionally, in some cases, fire management module 204 may analyze fire-related information 210 to identify an undesired condition resulting from a fire for an operator at a location and direct heterogeneous group of vehicles 300 to obtain information about the fire at the location. In particular, heterogeneous group of vehicles 300 may be directed to obtain information relating to at least one of the safety of the operator at the location and containment of the fire at the location.

In these depicted examples, number of satellites 302 may be configured to provide satellite imagery of a location in which a fire has been detected. Further, satellite imagery of this location and the area surrounding this location may be used in predicting the progress of a fire.

Assets 206 in FIG. 2 in the form of personnel 304 may be coordinated to perform various operations by fire management module 204. For example, one or more persons in personnel 304 may be coordinated to operate one or more vehicles in heterogeneous group of vehicles 300. Further, information may be displayed to personnel 304 identifying the operations that are to be performed by personnel 304. Communications with personnel 304 may include using, for example, voice, radios, video, and/or other types of media. For example, personnel 304 may communicate with each other and/or other human operators by exchanging voice communications using portable computers.

Number of sensor systems 306 may include at least one of smoke detectors 338, carbon dioxide detectors 340, radar systems 342, global positioning system units 344, camera systems 346, infrared camera systems 348, and/or other suitable types of sensor systems. Number of sensor systems 306 is configured to generate sensor data 350 that may form part of fire-related information 210 in FIG. 2. Number of sensor systems 306 may be, for example, fixed, moving, mounted on the ground, airborne, or mounted on ground vehicles.

Further, number of weather stations 308 may include any number of weather stations and/or weather devices configured to provide weather information 352 for the areas being monitored for fires and/or the areas in which fires have been detected. Weather information 352 forms part of fire-related information 210 in FIG. 2. Fire management module 204 may use weather information 352 to identify areas in which a fire may potentially occur, predict a path of expansion for a fire, predict whether additional fires may start in response to a fire that has been detected, and/or make other types of determinations and/or predictions.

In this illustrative example, fire management module 204 may also obtain fire-related information 210 from number of storage devices 310. Number of storage devices 310 may include any type of storage device storing fire-related information 210. For example, number of storage devices 310 may include a repository, such as repository 221 in FIG. 2, a number of databases, a number of servers, a number of hard drives, and/or other suitable types of storage devices.

Number of storage devices 310 may provide fire-related information 210 in the form of, for example, geographical information, maps, charts, historical data, statistical data, predictive algorithms, and/or other suitable information. In some illustrative examples, number of storage devices 310 may include operating parameters, constraints, schematics, and/or other suitable information for any number of assets 206 that may be used by fire management module 204 to coordinate assets 206.

Additionally, number of control stations 312 may be considered assets 206 when number of control stations 312 is configured to obtain information from other assets within assets 206 and provide this information to fire management module 204. In one advantageous embodiment, number of control stations 312 may be a ground station or an air traffic control tower configured to exchange information with manned aerial vehicles 324. In this embodiment, fire management module 204 may then communicate with manned aerial vehicles 324 through number of control stations 312.

Additionally, in this illustrative example, heterogeneous group of autonomous data sources 313 may include a group of heterogeneous data sources that is configured to generate and send data to fire management module 204 in FIG. 2. For example, heterogeneous group of autonomous data sources 313 may include autonomous sensor units. These autonomous sensor units may take the form of, for example, autonomous smart data origination components (ASDOC) and/or other suitable types of autonomous data sources. Further, heterogeneous group of autonomous data sources 313 may also include, for example, aeronautical source collection and service system (ASCASS), four dimensional time-variant multi-modal information system (4DTMIS), and other types of systems.

In different advantageous embodiments, a portion of computer system 200 in FIG. 2 may be present in a portion of these different types of assets 206. As used herein, when possible, a portion may be some or all of a system, group, or collection of items. With this type of implementation, this portion of these different types of assets 206 may include applications, artificial intelligence, neural-networks, and/or other suitable software for fire management module 204 for coordination of this portion of assets 206.

The illustration of assets 206 in FIG. 3 is not meant to imply physical or architectural limitations to the manner in which an advantageous embodiment may be implemented. Other components in addition to and/or in place of the ones illustrated may be used. Some components may be unnecessary. Also, the blocks are presented to illustrate some functional components. One or more of these blocks may be combined and/or divided into different blocks when implemented in an advantageous embodiment.

For example, in other illustrative examples, assets 206 may include lightning strike sensors, amphibious aircraft, fire fighting helicopters, object detection systems, radar systems, surveillance systems, rendezvous systems, thermal imaging systems, altimetry and flight control systems, target locating systems, optical systems, marine systems, ground control systems, vessel/vehicle traffic services, security systems, offboard communication systems, onboard communication systems, transit measuring systems, coordinate measuring systems, signal processing systems, phased array systems, broadcasting systems, electronic countermeasure systems, virtual systems, scanning systems, beamed signal systems, and/or other suitable types of assets.

In other illustrative examples, heterogeneous group of vehicles 300 may include marine vehicles, water vehicles, aquatic vehicles, and/or other suitable types of vehicles in addition to and/or in place of the ones shown. For example, a fire may occur at a platform located on the water. Heterogeneous group of vehicles 300 may include water vehicles 360 that are manned and/or unmanned. Water vehicles 360 may include, for example, ships, jet skis, boats, unmanned underwater vehicles, and/or other suitable types of water vehicles that may be used in detecting the fire, containing the fire, and/or monitoring the fire.

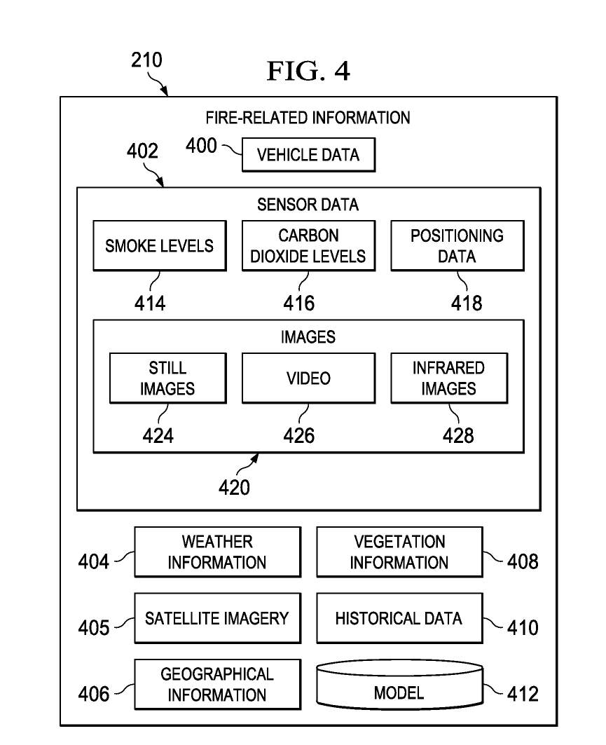

With reference now to FIG. 4, an illustration of different types of fire-related information is depicted in accordance with an advantageous embodiment. In this illustrative example, different types of fire-related information 210 from FIG. 2 are shown. As depicted, fire-related information 210 may include at least one of vehicle data 400, sensor data 402, weather information 404, satellite imagery 405, geographical information 406, vegetation information 408, historical data 410, model 412, and/or other suitable types of information.

Vehicle data 400 may include any information gathered by assets in the form of vehicles, such as heterogeneous group of vehicles 300 in FIG. 3. This data may include sensor data, images, audio generated by an operator of a vehicle, position information, and/or other suitable information.

Sensor data 402 may include, for example, without limitation, smoke levels 414, carbon dioxide levels 416, positioning data 418, images 420, and/or other suitable types of sensor data. Images 420 may include, for example, still images 424, video 426, infrared images 428, and/or other suitable types of images.

Weather information 404 may include, for example, information obtained from weather-related sensors, historical weather information, predicted weather information, a current wind speed and wind direction, a predicted wind speed and direction, and/or other suitable types of weather information. Weather information 404 may include weather information 352 obtained from number of weather stations 308 in FIG. 3 and/or other weather information obtained from other suitable sources.

In this illustrative example, satellite imagery 405 may be obtained from any of a number of satellites. Geographical information 406, vegetation information 408, historical data 410, model 412, and/or other suitable types of information may be obtained from a number of different sources. For example, these types of information may be obtained from a repository, such as repository 221 in FIG. 2 and/or number of storage devices 310 in FIG. 3.

Geographical information 406 may include maps, topographical information, geographical landmarks, and/or other suitable information. Vegetation information 408 includes an identification of the different types of plant life and vegetation in areas of interest. Historical data 410 may be historical data about previous fires that have occurred. Model 412 may include information about the behavior of a fire that may be used for simulating a fire and/or other suitable information.

The illustration of fire-related information 210 in FIG. 4 is not meant to imply physical or architectural limitations to the manner in which an advantageous embodiment may be implemented. Other components in addition to and/or in place of the ones illustrated may be used. Some components may be unnecessary. Also, the blocks are presented to illustrate some functional components. One or more of these blocks may be combined and/or divided into different blocks when implemented in an advantageous embodiment.

For example, in other illustrative examples, fire-related information 210 may include asset condition and capability information and asset operational support information in addition to and/or in place of the types of information described above. For example, for an unmanned aerial vehicle, the vehicle would provide information related to its condition, such as fuel remaining and systems health. The unmanned aerial vehicle would also provide information related to its capabilities, such as sensor type and fire suppressant capacity.

Fire-related information 210 may also include information related to operational support, such as refueling locations, water source locations, and fire suppressant resupply locations. For human operated assets, the condition and capability information may include operator time on-duty and/or other information useful to coordinating the detection, containment, and monitoring of fires.

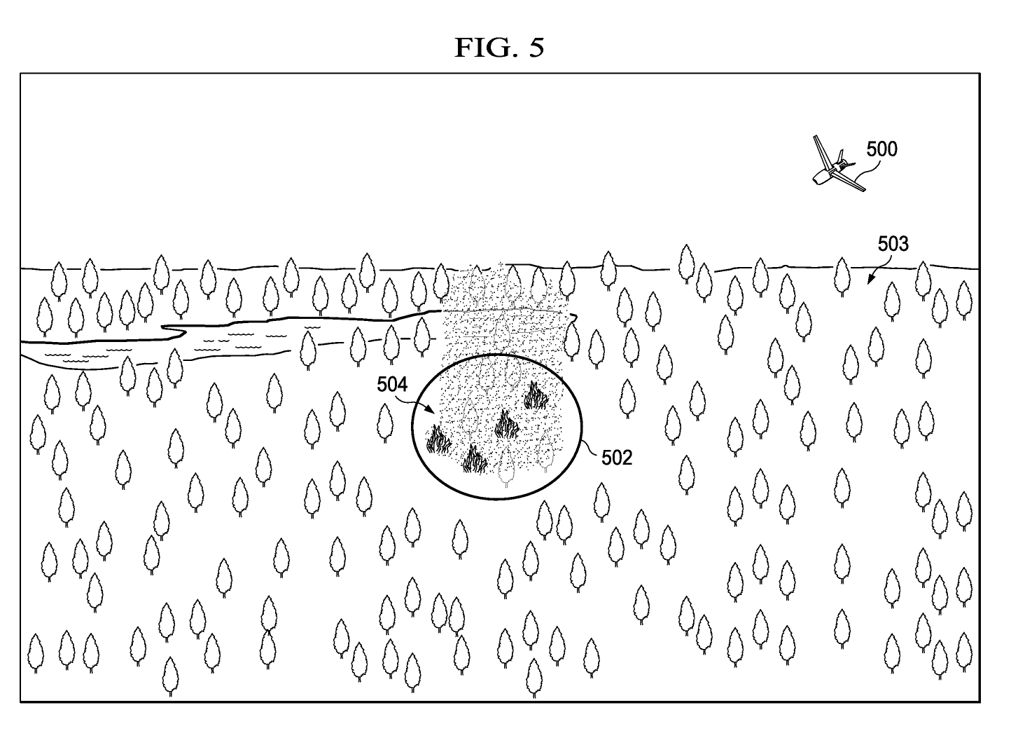

With reference now to FIG. 5, an illustration of an unmanned aerial vehicle flying towards a fire is depicted in accordance with an advantageous embodiment. In this illustrative example, unmanned aerial vehicle 500 is an example of one implementation for an asset in assets 206 in FIGS. 2 and 3. In particular, unmanned aerial vehicle 500 is an example of one implementation for one of unmanned aerial vehicles 328 in FIG. 3.

As depicted, unmanned aerial vehicle 500 may be flying towards location 502 in forest 503. Fire 504 is present in location 502. Unmanned aerial vehicle 500 has detected the presence of fire 504 at location 502 and is flying towards fire 504 to obtain fire-related information about fire 504. The coordinating of unmanned aerial vehicle 500 to fly towards fire 504 to obtain fire-related information about fire 504 in response to the detection of the presence of fire 504 may be performed by, for example, fire management module 204 in FIG. 2.

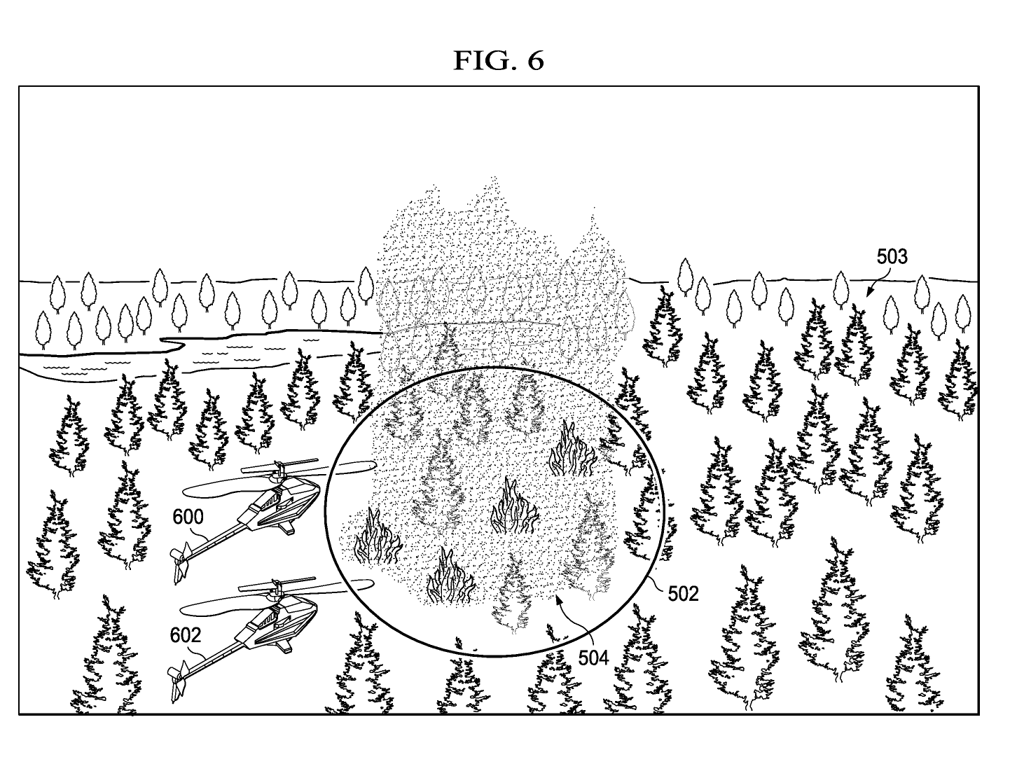

Turning now to FIG. 6, an illustration of unmanned aerial vehicles monitoring a fire in a forest is depicted in accordance with an advantageous embodiment. In this illustrative example, aerial monitoring unit 600 and aerial monitoring unit 602 are other examples of one implementation for one of unmanned aerial vehicles 328 in FIG. 3.

As depicted, fire management module 204 in FIG. 2 may coordinate aerial monitoring unit 600 and aerial monitoring unit 602 to monitor the status of fire 504 at location 502 in response to fire-related information collected about fire 504 by unmanned aerial vehicle 500 in FIG. 5. Aerial monitoring unit 600 and aerial monitoring unit 602 are coordinated by fire management module 204 to monitor the status of fire 504 just prior to, during, and/or after containment operations have been performed for fire 504.

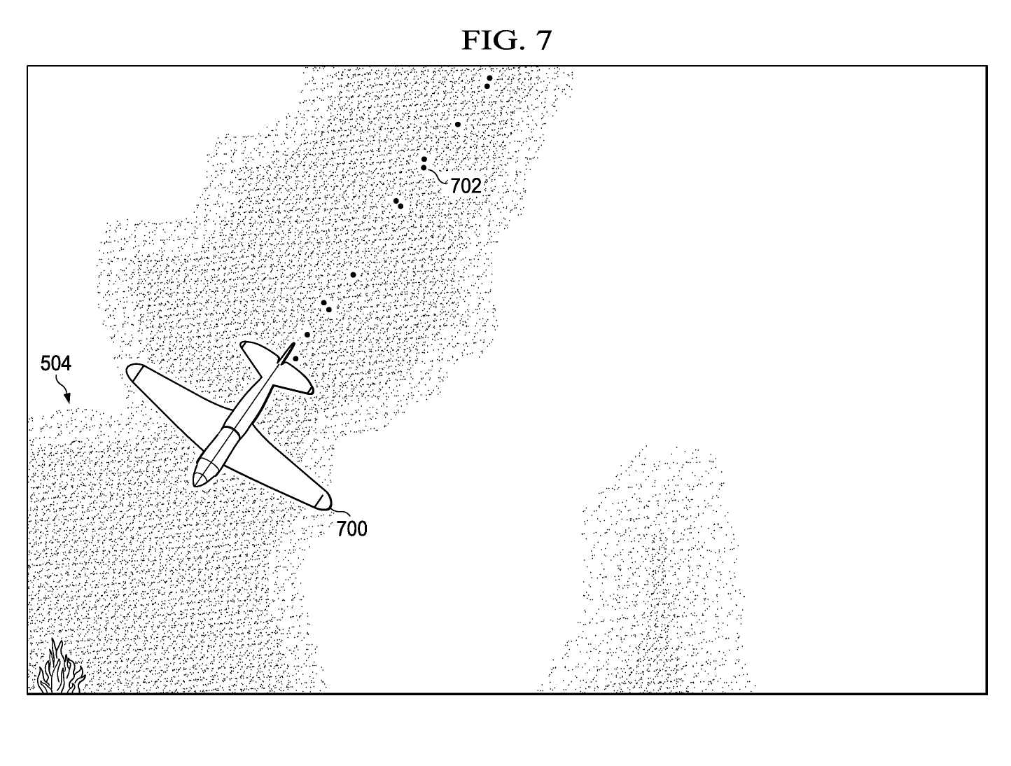

With reference now to FIG. 7, an illustration of a vehicle performing containment operations for a fire is depicted in accordance with an advantageous embodiment. In this illustrative example, aerial fire containment unit 700 is an example of one implementation for an asset in assets 206 in FIGS. 2 and 3. In particular, aerial fire containment unit 700 is an example of one implementation for manned aerial vehicles 324 in FIG. 3.

As depicted, fire management module 204 in FIG. 2 coordinates aerial fire containment unit 700 to perform containment operations on fire 504. In particular, an operator of aerial fire containment unit 700 is directed to drop water pods 702 on fire 504 to put out fire 504 and/or contain fire 504. Water pods 702 may be objects that are configured to release water upon contact with the ground and/or when a selected temperature has been reached.

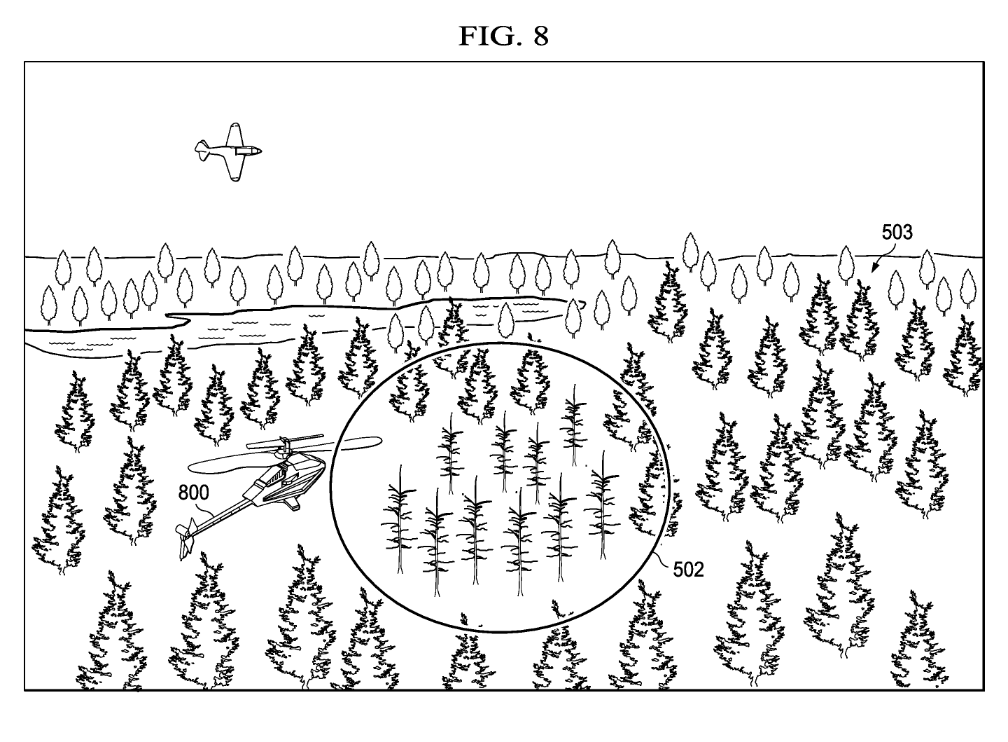

Turning now to FIG. 8, an illustration of an aerial vehicle monitoring unit monitoring a location at which a fire has been contained is depicted in accordance with an advantageous embodiment. In this illustrative example, aerial vehicle monitoring unit 800 is an example of one implementation for an asset in assets 206 in FIGS. 2 and 3. In particular, aerial vehicle monitoring unit 800 is an example of one implementation for manned aerial vehicles 324 in FIG. 3.

As depicted, aerial vehicle monitoring unit 800 is directed by fire management module 204 in FIG. 2 to monitor location 502 at which fire 504 from FIGS. 5-7 has been contained. More specifically, fire 504 has been put out at location 502. Aerial vehicle monitoring unit 800 may be coordinated to monitor location 502 and/or the area surrounding location 502 for a period of time to ensure that the fire does not start up again and/or that another fire does not start.

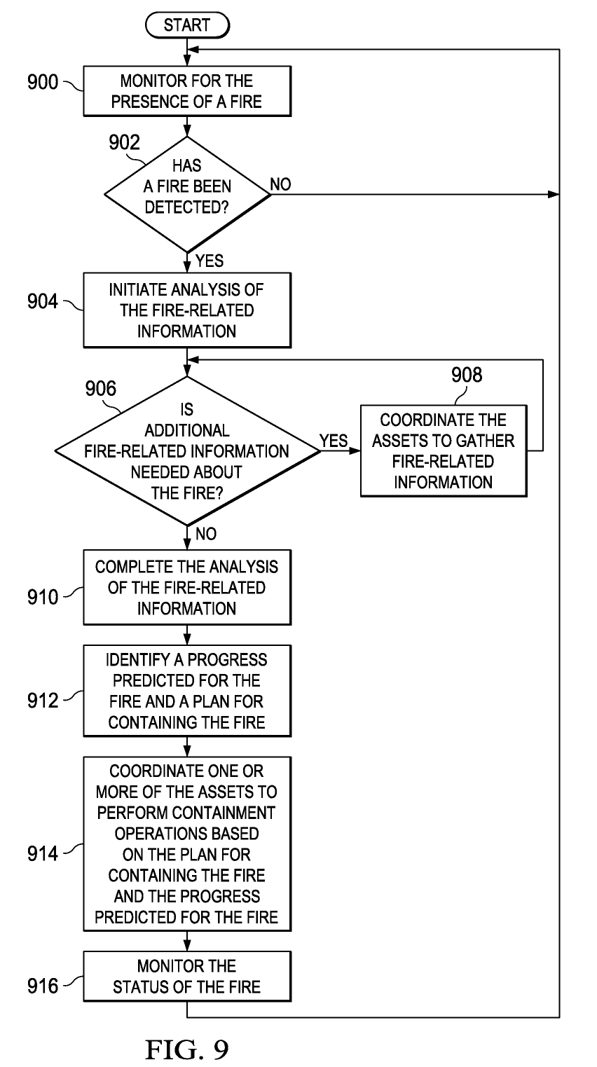

With reference now to FIG. 9, an illustration of a flowchart of a process for managing fires is depicted in accordance with an advantageous embodiment. The process illustrated in FIG. 9 may be implemented using fire management module 204 running in computer system 200 in FIG. 2.

The process begins by monitoring for the presence of a fire (operation 900). Operation 900 includes coordinating assets, such as assets 206, using, for example, detection coordination 212 in FIG. 2. Further, operation 900 may include obtaining information, such as fire-related information 210, by coordinating assets 206 using information gathering coordination 214 in FIG. 2.

Further, operation 900 includes receiving fire-related information from assets, such as, for example, a heterogeneous group of vehicles. A heterogeneous group of vehicles includes at least two vehicles that have a different configuration, different configurations, and/or are different in some other manner. In other words, the heterogeneous group of vehicles includes at least two vehicles that are dissimilar.

The process then determines whether a fire has been detected (operation 902). In this illustrative example, operation 902 may be performed using fire-related information 210 provided by assets 206 in FIG. 2. In some cases, the determination may be made by one or more of assets 206 when a portion of fire management module 204 is running on one or more of assets 206.

If a fire has not been detected, the process returns to operation 900 as described above. Otherwise, the process initiates analysis of the fire-related information (operation 904). Thereafter, the process determines whether additional fire-related information is needed about the fire (operation 906). If additional fire-related information is needed, the process coordinates the assets to gather fire-related information (operation 908). For example, in operation 908, one or more of the assets may be coordinated to monitor the fire and/or the location in which the fire occurs to obtain the necessary fire-related information. In some cases, additional information may be obtained from assets other than vehicles, such as a repository.

The process then returns to operation 906. If additional fire-related information is not needed, the process completes the analysis of the fire-related information (operation 910). Completion of the analysis may include, for example, without limitation, running a simulation using the fire-related information to predict a progress of the fire.

Next, the process identifies a progress predicted for the fire and a plan for containing the fire (operation 912). The progress may include, for example, a predicted path of expansion for the fire, predicted smoke levels, and/or other suitable information about the fire. Further, operation 912 may include generating a result based on the analysis completed in operation 910. The result may include the progress predicted for the fire, a map of a current location of a fire, and/or other suitable types of information that may be used for managing the fire.

Thereafter, the process coordinates one or more of the assets to perform containment operations based on the plan for containing the fire and the progress predicted for the fire (operation 914). Further, operation 914 may also include coordinating one or more assets to direct the vehicles in a particular direction and/or direct the vehicles to perform other suitable operations. The process monitors the status of the fire (operation 916), with the process then returning to operation 900 as described above.

In this illustrative example, operation 916 may be performed while operation 914 is being performed to contain the fire. Further, operation 916 may also be performed after operation 916 has been performed and the fire has been fully contained to monitor for a reoccurrence of the fire, smoke levels, carbon dioxide levels, and/or other factors.

The flowchart and block diagrams in the different depicted embodiments illustrate the architecture, functionality, and operation of some possible implementations of apparatus, methods, and computer program products. In this regard, each block in the flowchart or block diagrams may represent a module, segment, or portion of computer usable or readable program code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

For example, operation 914 and operation 916 in FIG. 9 may be performed at substantially the same time in some cases. In other illustrative examples, operation 908 may be performed while all of the other operations in FIG. 9 are being performed. In still other illustrative examples, after operation 916 is performed, the process may terminate or wait for user input instead of returning to operation 900 in FIG. 9.

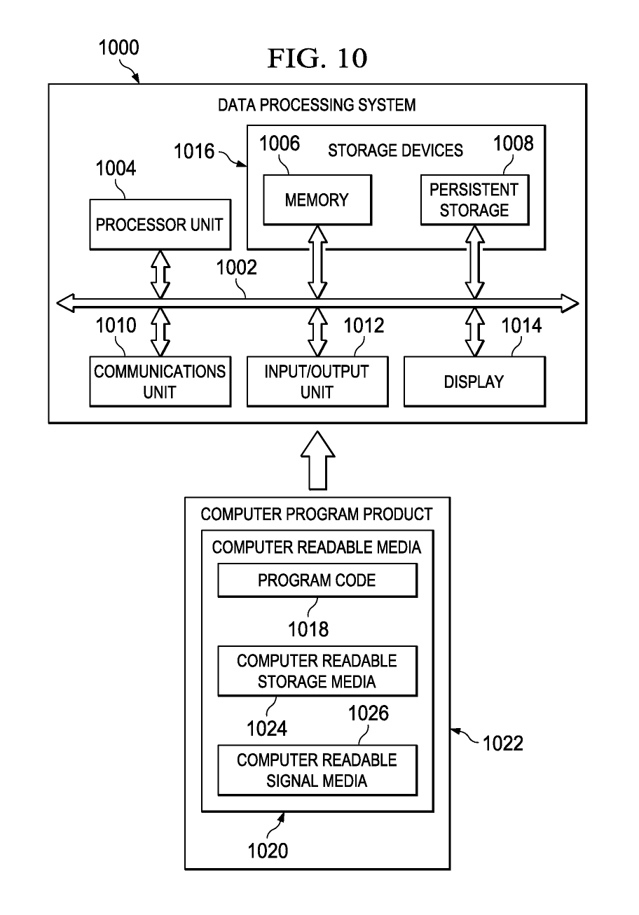

Turning now to FIG. 10, an illustration of a data processing system is depicted in accordance with an advantageous embodiment. In this illustrative example, data processing system 1000 may be used in implementing one or more of number of computers 202 for computer system 200 in FIG. 2. As depicted, data processing system 1000 includes communications fabric 1002, which provides communications between processor unit 1004, memory 1006, persistent storage 1008, communications unit 1010, input/output (I/O) unit 1012, and display 1014.

Processor unit 1004 serves to execute instructions for software that may be loaded into memory 1006. Processor unit 1004 may be a number of processors, a multi-processor core, or some other type of processor, depending on the particular implementation. A number, as used herein with reference to an item, means one or more items. Further, processor unit 1004 may be implemented using a number of heterogeneous processor systems in which a main processor is present with secondary processors on a single chip. As another illustrative example, processor unit 1004 may be a symmetric multi-processor system containing multiple processors of the same type.

Memory 1006 and persistent storage 1008 are examples of storage devices 1016. A storage device is any piece of hardware that is capable of storing information, such as, for example, without limitation, data, program code in functional form, and/or other suitable information either on a temporary basis and/or a permanent basis. Storage devices 1016 may also be referred to as computer readable storage devices in these examples. Memory 1006, in these examples, may be, for example, a random access memory or any other suitable volatile or non-volatile storage device. Persistent storage 1008 may take various forms, depending on the particular implementation.

For example, persistent storage 1008 may contain one or more components or devices. For example, persistent storage 1008 may be a hard drive, a flash memory, a rewritable optical disk, a rewritable magnetic tape, or some combination of the above. The media used by persistent storage 1008 also may be removable. For example, a removable hard drive may be used for persistent storage 1008.

Communications unit 1010, in these examples, provides for communications with other data processing systems or devices. In these examples, communications unit 1010 is a network interface card. Communications unit 1010 may provide communications through the use of either or both physical and wireless communications links.

Input/output unit 1012 allows for input and output of data with other devices that may be connected to data processing system 1000. For example, input/output unit 1012 may provide a connection for user input through a keyboard, a mouse, and/or some other suitable input device. Further, input/output unit 1012 may send output to a printer. Display 1014 provides a mechanism to display information to a user.

Instructions for the operating system, applications, and/or programs may be located in storage devices 1016, which are in communication with processor unit 1004 through communications fabric 1002. In these illustrative examples, the instructions are in a functional form on persistent storage 1008. These instructions may be loaded into memory 1006 for execution by processor unit 1004. The processes of the different embodiments may be performed by processor unit 1004 using computer-implemented instructions, which may be located in a memory, such as memory 1006.

These instructions are referred to as program code, computer usable program code, or computer readable program code that may be read and executed by a processor in processor unit 1004. The program code in the different embodiments may be embodied on different physical or computer readable storage media, such as memory 1006 or persistent storage 1008.

Program code 1018 is located in a functional form on computer readable media 1020 that is selectively removable and may be loaded onto or transferred to data processing system 1000 for execution by processor unit 1004. Program code 1018 and computer readable media 1020 form computer program product 1022 in these examples. In one example, computer readable media 1020 may be computer readable storage media 1024 or computer readable signal media 1026.

Computer readable storage media 1024 may include, for example, an optical or magnetic disk that is inserted or placed into a drive or other device that is part of persistent storage 1008 for transfer onto a storage device, such as a hard drive, that is part of persistent storage 1008. Computer readable storage media 1024 also may take the form of a persistent storage, such as a hard drive, a thumb drive, or a flash memory, that is connected to data processing system 1000. In some instances, computer readable storage media 1024 may not be removable from data processing system 1000.

In these examples, computer readable storage media 1024 is a physical or tangible storage device used to store program code 1018, rather than a medium that propagates or transmits program code 1018. Computer readable storage media 1024 is also referred to as a computer readable tangible storage device or a computer readable physical storage device. In other words, computer readable storage media 1024 is a media that can be touched by a person.

Alternatively, program code 1018 may be transferred to data processing system 1000 using computer readable signal media 1026. Computer readable signal media 1026 may be, for example, a propagated data signal containing program code 1018. For example, computer readable signal media 1026 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some advantageous embodiments, program code 1018 may be downloaded over a network to persistent storage 1008 from another device or data processing system through computer readable signal media 1026 for use within data processing system 1000. For instance, program code stored in a computer readable storage medium in a server data processing system may be downloaded over a network from the server to data processing system 1000. The data processing system providing program code 1018 may be a server computer, a client computer, or some other device capable of storing and transmitting program code 1018.

The different components illustrated for data processing system 1000 are not meant to provide architectural limitations to the manner in which different embodiments may be implemented. The different advantageous embodiments may be implemented in a data processing system including components in addition to or in place of those illustrated for data processing system 1000. Other components shown in FIG. 10 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 1004 may take the form of a hardware unit that has circuits that are manufactured or configured for a particular use. This type of hardware may perform operations without needing program code to be loaded into a memory from a storage device to be configured to perform the operations.

For example, when processor unit 1004 takes the form of a hardware unit, processor unit 1004 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 1018 may be omitted because the processes for the different embodiments are implemented in a hardware unit.

In still another illustrative example, processor unit 1004 may be implemented using a combination of processors found in computers and hardware units. Processor unit 1004 may have a number of hardware units and a number of processors that are configured to run program code 1018. With this depicted example, some of the processes may be implemented in the number of hardware units, while other processes may be implemented in the number of processors.

In another example, a bus system may be used to implement communications fabric 1002 and may be comprised of one or more buses, such as a system bus or an input/output bus. Of course, the bus system may be implemented using any suitable type of architecture that provides for a transfer of data between different components or devices attached to the bus system.

Additionally, a communications unit may include a number of devices that transmit data, receive data, or transmit and receive data. A communications unit may be, for example, a modem or a network adapter, two network adapters, or some combination thereof. Further, a memory may be, for example, memory 1006, or a cache, such as found in an interface and memory controller hub that may be present in communications fabric 1002.

Thus, the different advantageous embodiments provide a fire management system that may be used to detect fires, contain fires, or perform a combination of the two. In an advantageous embodiment, a computer system is configured to receive fire-related information from a plurality of different types of vehicles. The computer system is configured to analyze the fire-related information to generate a result and coordinate an operation of the plurality of different types of vehicles using the result.

In this manner, the different advantageous embodiments provide a system for managing fires that integrates information from many different types of assets and coordinates operations performed by these different types of assets to manage fires.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A fire management system comprising:
a computer system configured to receive fire-related information from at least a portion of a heterogeneous group of vehicles, analyze the fire-related information to generate a result, and coordinate an operation of the heterogeneous group of vehicles using the result.

2. The fire management system of claim 1, wherein in being configured to coordinate the operation of the heterogeneous group of vehicles using the result, the computer system is configured to coordinate the operation of the heterogeneous group of vehicles to perform at least one of monitoring for a fire, gathering information about the fire, performing containment operations on the fire, and supporting personnel at a location in which the fire is located.

3. The fire management system of claim 1, wherein the computer system is configured to run a simulation to detect a potential fire condition using the fire-related information.

4. The fire management system of claim 1, wherein the computer system is configured to run a simulation to generate the result in a form of a progress predicted for a fire and wherein in being configured to coordinate the operation of the heterogeneous group of vehicles using the result, the computer system is configured to send directions to coordinate movement of the heterogeneous group of vehicles based on the progress predicted for the fire.

5. The fire management system of claim 1, wherein the computer system is configured to analyze the fire-related information to identify an undesired condition resulting from a fire for an operator at a location and direct a plurality of different types of vehicles to obtain information about the fire at the location relating to at least one of safety of the operator and containment of the fire.

6. The fire management system of claim 5, wherein the fire-related information is sent to a human operator in which the human operator makes decisions using the fire-related information.

7. The fire management system of claim 1, wherein the computer system sends tasks to the heterogeneous group of vehicles to coordinate the operation of the heterogeneous group of vehicles.

8. The fire management system of claim 1, wherein the computer system comprises a number of computers located in at least one of a ground station and at least a portion of the heterogeneous group of vehicles.

9. The fire management system of claim 1, wherein the computer system is further configured to receive a portion of the fire-related information from at least one of a satellite system, a sensor system, and a person.

10. The fire management system of claim 1, wherein the fire-related information comprises at least one of first information about potential fire conditions at a location and second information about a fire at the location.

11. The fire management system of claim 1, wherein the result is an identification of a number of locations having a potential for a fire and wherein the computer system is configured to coordinate the operation of the heterogeneous group of vehicles to monitor the number of locations using the result.

12. The fire management system of claim 1, wherein the result is an identification of a number of locations with a fire and wherein the computer system is configured to coordinate the operation of the heterogeneous group of vehicles to obtain additional information about the fire at the number of locations.

13. The fire management system of claim 12, wherein the heterogeneous group of vehicles comprises types of vehicles selected from at least two of a manned vehicle and an unmanned aerial vehicle.

14. A method for managing fires, the method comprising:
receiving fire-related information from a heterogeneous group of vehicles;
analyzing the fire-related information to generate a result; and
coordinating an operation of the heterogeneous group of vehicles using the result.

15. The method of claim 14, wherein the step of coordinating the operation of the heterogeneous group of vehicles using the result comprises:
coordinating the operation of the heterogeneous group of vehicles to perform at least one of monitoring for a fire, gathering information about the fire, and performing containment operations on the fire; and
supporting personnel at a location in which the fire is located.

16. The method of claim 14 further comprising:
running a simulation to generate the result in a form of a progress predicted for a fire; and wherein the step of coordinating the operation of the heterogeneous group of vehicles using the result comprises:
sending directions to coordinate movement of the heterogeneous group of vehicles based on the progress predicted for the fire.

17. The method of claim 14 further comprising:
analyzing the fire-related information to identify an undesired condition resulting from a fire for an operator at a location; and
directing a plurality of different types of vehicles to obtain information about a fire at the location relating to at least one of safety of the operator and containment of the fire.

18. The method of claim 14 further comprising:
sending tasks to the heterogeneous group of vehicles to coordinate the operation of the heterogeneous group of vehicles.

19. A fire management system comprising:
a computer system configured to receive fire-related information from at least a first portion of a plurality of assets, analyze the fire-related information to generate a result, and coordinate an operation of a second portion of the plurality of assets using the result.

20. The fire management system of claim 19, wherein an asset in the plurality of assets is selected from one of a vehicle in a heterogeneous group of vehicles, a sensor system, a weather station, a storage device, a control station, a surveillance system, and an autonomous data source.
